(19) United States
(12) Patent Application Publication
(10) Pub. No.: US 2018/0126329 A1
(43) Pub. Date: May 10, 2018

(54) TUBE SHEET DESIGN FOR USE IN AIR SEPARATION MODULES

(71) Applicant: EATON CORPORATION, Cleveland, OH (US)

(72) Inventors: Martin Philip Holland, Colleyville, TX (US); Joseph Brice Diller, Granbury, TX (US); Dominic Ashton, Ladera Ranch, CA (US)

(73) Assignee: EATON CORPORATION, Cleveland, OH (US)

(21) Appl. No.: 15/799,233

(22) Filed: Oct. 31, 2017

Related U.S. Application Data
(60) Provisional application No. 62/417,703, filed on Nov. 4, 2016.

(51) Int. Cl. B01D 53/22; B01D 71/46; B01D 63/04; B64D 37/32

(52) U.S. Cl. CPC B01D 53/228; B01D 71/46; B01D 2053/224; B64D 37/32; B01D 63/04

(57) ABSTRACT

An air separation module (ASM) is described herein that can include an outer shell having a first end, a second end, and a tubular outer wall disposed between the first end and the second end. The ASM can further include a hollow fiber membrane. The hollow fiber member can include a first tubesheet and a second tubesheet. A plurality of hollow fibers can extend between the first tubesheet and the second tubesheet. At least one of the first tubesheet and the second tubesheet can include a hygrophobic material.

### RELATED APPLICATION

This application claims the benefit of U.S. Provisional Patent Application No. 62/417,703, filed Nov. 4, 2016, and entitled “OZONE RESISTANT TUBE SHEET DESIGN FOR USE IN AIR SEPARATION MODULES,” which is incorporated herein in its entirety.

### TECHNICAL FIELD

This disclosure relates to air separation modules (ASMs). More particularly, this disclosure relates to ASMs having improved ozone and thermo-oxidative aging resistance.

### BACKGROUND

Air Separation Modules (ASMs) are devices that can be configured in an aircraft's fuel tank flammability reduction system to remove oxygen and/or contaminants (e.g., hydrocarbons and aldehydes) from an airstream (e.g., an inlet feed gas) to provide a nitrogen-enriched airstream. The nitrogen-enriched airstream can be dumped into a fuel tank ullage, a region of an aircraft that contains fuel vapors. An ASM can include an external shell, an inlet port for receiving the airstream, a first outlet port for releasing the nitrogen-enriched airstream and a second outlet port for releasing the removed oxygen and/or contaminates from the airstream. Within the external shell, hollow fiber membranes can be disposed. The hollow fibers can be bundled via epoxy tubesheets. Epoxy tubesheets can be used to hold the hollow fibers in place to provide an airtight seal between each fiber and the external shell. However, as a result of contaminants in the airstream, humidity and/or changes in temperature (e.g., during altitude changes of the aircraft), the epoxy tubesheets degrade (e.g., crack) and pass through the oxygen and/or contaminants to the fuel tank.

For example, atmospheric ozone (O₃) can be introduced into the airstream as a result of solar ultraviolet radiation converting oxygen present in the airstream. Additionally, or alternatively, atmospheric ozone can be introduced into the airstream from an ozone converter providing the airstream to the ASM. ASMs, in part, depend on ozone converters to reduce a concentration of atmospheric ozone in the airstream. However, ozone converters are limited to dissociating a portion of atmospheric ozone to oxygen, and begin to diminish in efficiency and effectiveness in converting atmospheric ozone when nearing the end of their lifetime.

Epoxy resins of the tubesheets can become degraded through a mechanism known as thermo-oxidative aging. Causes of such degradation can include atmospheric ozone, temperature variations and/or humidity. Thermo-oxidation causes a chemical structure of the epoxy resins to be altered by chain scission, recombination and elimination reactions. Consequently, the tubesheets become weakened and susceptible to cracking, which can lead to the airstream leaking to a permeate side from an inlet side of the ASM. Leakage of the airstream to the permeate side reduces an efficiency of the ASM to provide a given nitrogen concentration of the nitrogen-enriched stream.

Accordingly, a need exists for a tube sheet design having improved resistance to atmospheric ozone, temperature variations, and humidity.

### SUMMARY

In an example, an air separation module (ASM) can include an outer shell having a first end, a second end, and a tubular outer wall disposed between the first end and the second end. The ASM can include a hollow fiber membrane with a first tubesheet, a second tubesheet, and a plurality of hollow fibers extending between the first tubesheet and the second tubesheet. At least one of the first tubesheet and the second tubesheet can include a hygrophobic material. In some examples, the hygrophobic material is a cycloaliphatic epoxy resin.

In another example, the first or the second tubesheet can include a curing agent mixed with the hygroscopic material in a ratio of about 2:1 to about 1.5:1. In an example, the ratio of hygroscopic material to curing agent is 1.75:1.

### BRIEF DESCRIPTION OF THE DRAWINGS

FIG. 1 is a perspective view of an example of an air separation module.

FIG. 2 is a cross-sectional view of an example of an air separation module.

FIGS. 3A-3D are exemplary photographs of tubesheet/hollow fiber membrane coupons made with a cycloaliphatic epoxy resin material, depicted over a 72 hour span of time of exposure to concentrated ozone.

FIGS. 4A-4D are exemplary photographs of tubesheet/hollow fiber membrane coupons made with a Novolac epoxy resin material, depicted over a 72 hour span of time of exposure to concentrated ozone.

FIGS. 5A-5D are exemplary photographs of tubesheet/hollow fiber membrane coupons made with a Hexion epoxy resin material, depicted over a 72 hour span of time of exposure to concentrated ozone.

### DETAILED DESCRIPTION

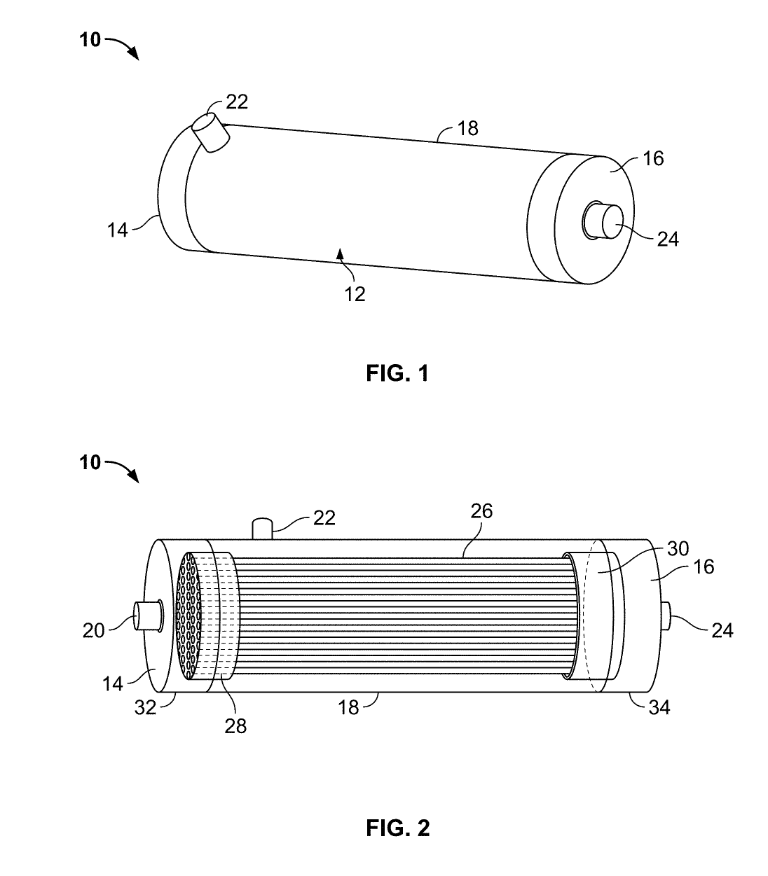

FIGS. 1 and 2 show a perspective view and a cross-sectional view, respectively, of an example, of an air separation module (ASM) 10. In some examples, the ASM 10 can be employed in aerospace applications, such as fuel tank flammability reduction applications. Examples of ASMs that can be used in aerospace applications are commercially available from Electroid Company © and Cobham plc ©, among other suppliers. Although the ASM 10 is described herein is in context of aerospace applications, it should be understood that the ASM 10 can be used in any application were oxygen and/or contaminants need to be removed from an associated airstream.

As illustrated in FIGS. 1 and 2, the ASM 10 can include an outer shell 12 having a first end 14, a second end 16. A tubular outer wall 18 can be disposed between the first end 14 and the second end 16. The outer shell 12 can be made of any suitable material, such as steel or aluminum. The ASM 10 can further include an inlet 20 that can be disposed through the first end 14, a side vent 22 that can be disposed through the tubular outer wall 18, and an outlet 24 that can disposed through the closed second end 16.

The ASM 10 can be configured to receive at the inlet 20 an airstream (e.g., engine bleed air, a feed gas, or the like) that contains atmospheric ozone (O₃) and contaminants, such as hydrocarbons and aldehydes. Upon entering the inlet 20, the airstream can be passed through a hollow fiber bundle 26. The hollow fiber bundle 26 can include a plurality of hollow fibers. The hollow fiber bundle 26 can be configured to separate the airstream into a first exhaust stream (permeate), and a second exhaust stream (retentate). The first exhaust stream can include oxygen, carbon dioxide, and water. The second exhaust stream can include substantially nitrogen (e.g., 99% nitrogen by concentration) with a low permeability. The ASM 10 can be configured to pass the first exhaust stream to the side vent 22, and the second exhaust stream to the outlet 24.

The hollow fiber bundle 26 can be positioned within the outer shell 12 and configured to extend along a length of the outer shell 12 from the first end 14 to the second end 16. The hollow fiber bundle 26 can be secured in place at each end 14 and 16 by a hollow fiber membrane that can include epoxy tubesheets 28 and 30. The epoxy tubesheets 28 and 30 can hold the hollow fibers in place, and provide an airtight seal between each fiber and the outer shell 12. The hollow fibers can be secured within the tubesheets 28 and 30 by any suitable method.

In an example, to form a tubesheet, such as illustrated in FIG. 2, a container, such as an aluminum ring, can be filled with a suitable tubesheet epoxy resin material, and at least a portion of the hollow fibers can be disposed within the container. The epoxy resin can then be allowed to set. Upon setting, ends of the tubesheet-material covering at least the portion of the hollow fibers can be machined off to expose the ends of the hollow fibers. The resulting tubesheets 28 and 30 can have a thickness of about 2.5 to 3 inches (in). Additionally, or alternatively, endcaps 32 and 34 can be positioned over the tubesheets 28 and 30 to enclose the first and second ends 14 and 16, respectively.

In some examples, at least one of the tubesheets 28 and 30 can include ozone resistant hygrophobic materials. Additionally, or alternatively, at least one of the tubesheets 28 and 30 can include a curing agent, such as described herein. The hygrophobic material and the curing agent can be mixed together in a ratio of about 2:1 to about 1.5:1. Alternatively, the hygrophobic material and the curing agent can be mixed together in a ratio of about 1.75:1.

The hygrophobic materials can be used to reduce effects of ozone degradation and thermo-oxidative aging. Using tubesheets 28 and 30 with hygrophobic materials can substantially improve an operational life of the tubesheets, and consequently an efficiency of the ASM 10. Furthermore, using tubesheets 28 and 30 with hygrophobic materials can decrease a dependency on an upstream ozone converter for the ASM 10. Accordingly, the ASM 10 can effectively remove atmospheric ozone that had failed to be removed by the upstream ozone converter

The hygrophobic material can include at least a cycloaliphatic epoxy resin. In an example, the cycloaliphatic epoxy resin can be a resin that is commercially available from Cooper Power Systems under a tradename NOVA. Cycloaliphatic epoxy resins can be characterized as having molecular structures that can include non-aromatic saturated rings. Cycloaliphatic epoxy resins are known for having inherently low viscosity, improved weatherability, and electrical performance.

The following examples are intended in a non-limiting way illustrate a performance of cycloaliphatic epoxy resin sheet tubes, such as described in context of FIGS. 1 and 2, in contrast to tubesheets constructed with different types of epoxy resins.

### EXAMPLES

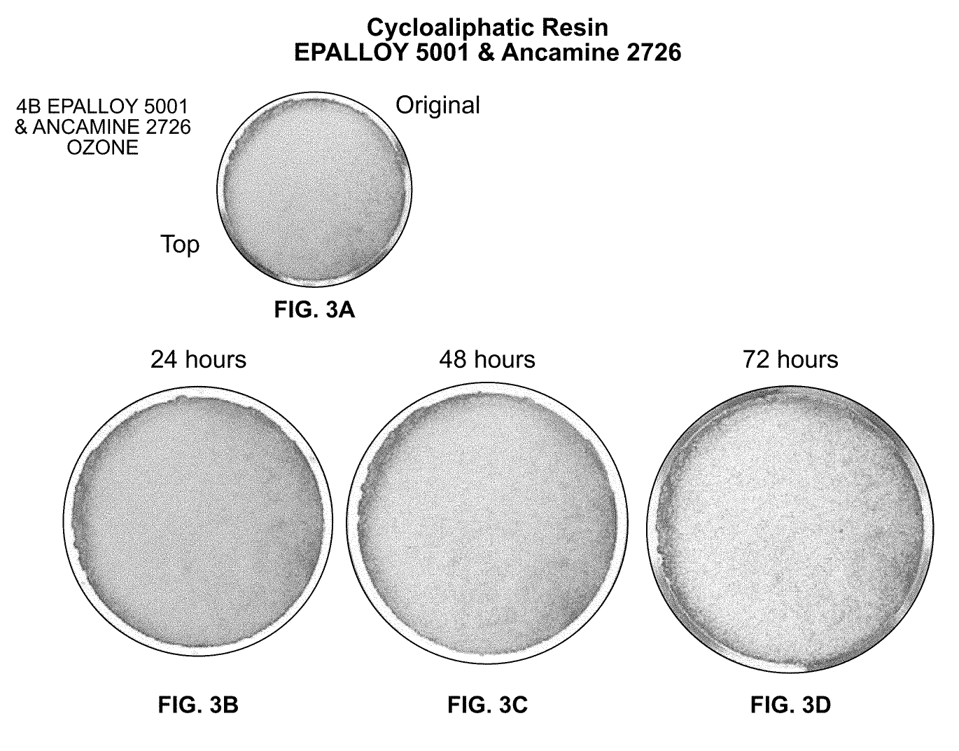

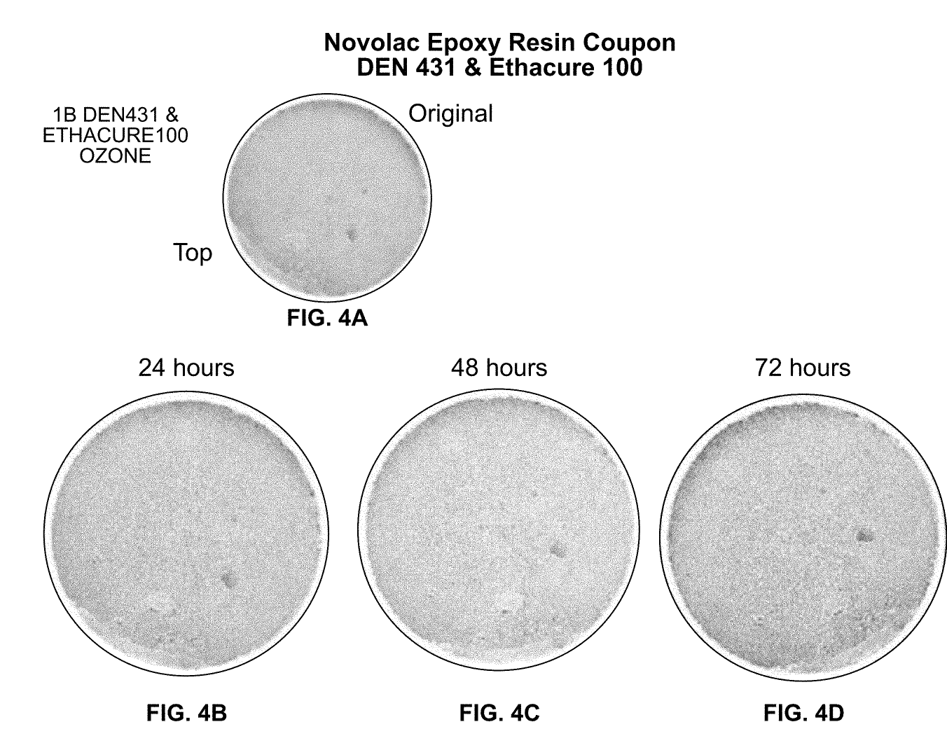

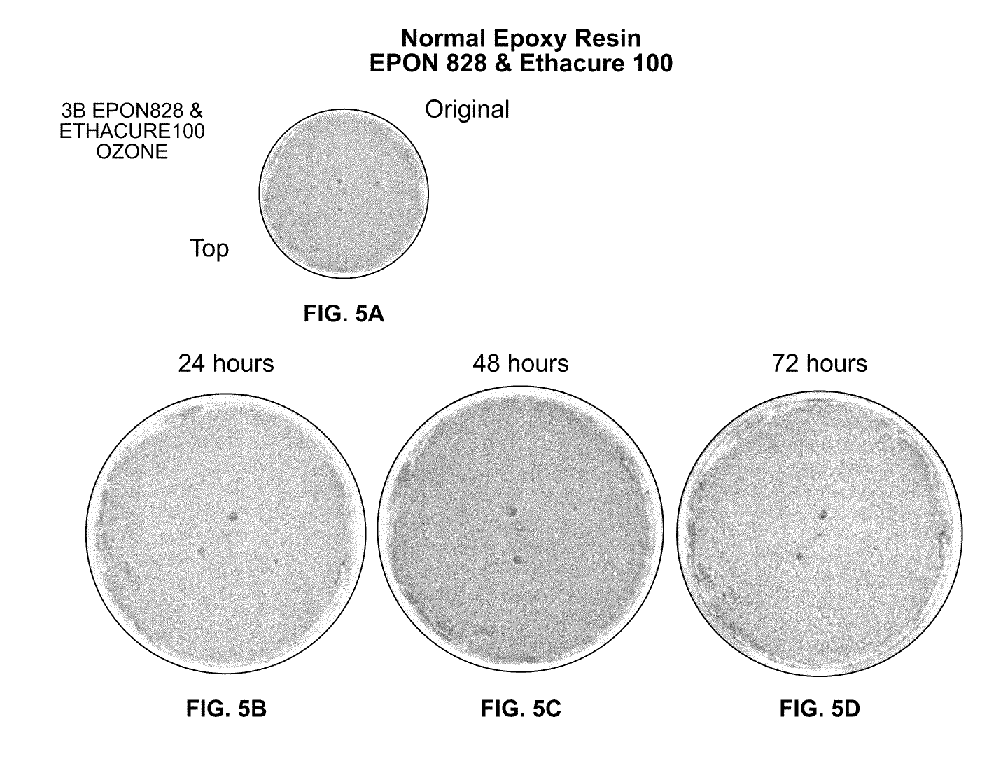

In an example, coupon testing was carried out to evaluate a performance of cycloaliphatic epoxy resin sheet tubes relative to tubesheets made with other typical aerospace epoxy resins. Sample tubesheet coupons were manufactured containing hollow fibers potted in an epoxy resin that includes: (1) Epalloy 5001, an accelerated epoxidized hydrogenated bisphenol A, purchased from CVC Thermoset Specialties, mixed in a ratio of 100:57.5 with curing agent Ancamine 2726, purchased from Air Products (FIG. 3A), (2) DEN 431, a semi-solid product of epichlorohydrin and phenol-formaldehyde novolac, purchased from Novolac, mixed in a ratio of 4:1 with curing agent Ethacure 100, purchased from Albemarle Corporation (FIG. 4A), and (3) EPON 828, a clear difunctional bisphenol A/epichlorohydrin derived liquid epoxy resin, purchased from Hexion, Inc., mixed in a ratio of 4:1 with curing agent Ethacure 100 (FIG. 5A). The resulting coupons were about 2 inches in diameter and 0.75 inches in thickness.

To form the sample tubesheet coupons with DEN 431 and EPON 828, the epoxy resins were heated to about 180 degrees Fahrenheit (° F.) to reduce a viscosity and to allow for vacuum degas to remove entrapped air. The sample tubesheet coupons were then gravity poured into a coupon mold and allowed to harden for about two (2) days. Subsequently, the sample tubesheet coupons were machined to appropriate dimensions to expose at least a portion of the hollow fibers.

The Epalloy 5001, on the other hand, had a lower viscosity at room temperature, which allowed for vacuum degassing to take place without heating the sample tubesheet coupons. The Epalloy 5001 epoxy resin/curing agent mixture was centrifugal cast into the coupon mold to allow the mixture flow around the fibers and create the tubesheet coupon. The viscosity of this mixture was substantially higher than the previous two samples and had a pot time of approximately thirty (30) minutes, and fully hardened after two hours with heat of about 150° F.

As illustrated in FIGS. 3-5, laboratory environment coupon samples made with the cycloaliphatic resin (FIG. 3) exposed to 250 pphm/vol (2.5 ppm) of ozone for seventy-two (72) hours showed little or no degradation compared to coupons prepared with Novolac and normal epoxy resins (as illustrated in FIGS. 4 and 5). The Novolac and normal epoxy resin coupons both showed evidence of discoloration and potential embrittlement at the epoxy to metal housing boundary. From the foregoing examples, it is apparent that the Novolac and normal epoxy resin materials were prone to thermos-oxidative degradation, cracking, and material corrosion from acids and alkalis formed by the contaminants in the feed gas.

It should now be understood that examples provided herein relate to improved tubesheets, which have increased ozone, temperature and humidity resistance. It is noted that the terms “substantially” and “about” can be utilized herein to represent the inherent degree of uncertainty that can be attributed to any quantitative comparison, value, measurement, or other representation. These terms are also utilized herein to represent the degree by which a quantitative representation may vary from a stated reference without resulting in a change in the basic function of the subject matter at issue. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

While particular examples have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An air separation module comprising:
an outer shell having a first end, a second end, and a tubular outer wall disposed between the first end and the second end; and
a hollow fiber membrane comprising a first tubesheet, a second tubesheet, and a plurality of hollow fibers extending between the first tubesheet and the second tubesheet, wherein at least one of the first tubesheet and the second tubesheet comprises a hygrophobic material.

2. The air separation module of claim 1, wherein the hygrophobic material is a cycloaliphatic epoxy resin.

3. The air separation module of claim 2, wherein at least the first tubesheet or the second tubesheet further comprises a curing agent.

4. The air separation module of claim 3, wherein the hygrophobic material and the curing agent are mixed together in a ratio of about 2:1 to about 1.5:1.

5. The air separation module of claim 3, wherein the hygrophobic material and the curing agent are mixed together in a ratio of about 1.75:1.

6. The air separation module of claim 2, further comprising an inlet disposed through the first end, and a plurality of outlets, wherein a first outlet of the plurality of outlets is disposed through the tubular outer wall and a second outlet of the plurality of outlets is disposed through the second end.

7. The air separation module of claim 6, wherein the plurality of hollow fibers form a hollow fiber bundle, wherein the hollow fiber bundle is to separate an instream entering the inlet into a first airstream and a second airstream.

8. The air separation module of claim 7, wherein the hollow fiber bundle is to pass the first airstream to first outlet and the second airstream to the second outlet.

9. The air separation module of claim 7, wherein first airstream comprises at least oxygen, carbon dioxide and water, and the second airstream comprises nitrogen.
